(19) United States
(12) Patent Application Publication
(10) Pub. No.: US 2004/0025485 A1
(43) Pub. Date: Feb. 12, 2004

(54) Air filter with molded end caps

(76) Inventor: Dong-Tasi Lee, Chang-Hua Hsien (TW)

Correspondence Address: FOLEY AND LARDNER, SUITE 500, 3000 K STREET NW, WASHINGTON, DC, 20007, US

(21) Appl. No.: 10/212,685

(22) Filed: Aug. 7, 2002

(51) Int. Cl. B01D 46/00

(52) U.S. Cl. 55/486; 55/498; 55/502

(57) ABSTRACT

An air filter includes a tubular outer mesh body, a tubular inner mesh body, a filter layer, a first end cap and a second end cap. The first and second end caps are molded from plastic foam material, have end portions of the inner and outer mesh bodies embedded therein, and fill perforations in the end portions of the inner and outer mesh bodies. The first and second end caps cooperate to position the filter layer between the inner and outer mesh bodies.

### BACKGROUND OF THE INVENTION

1. Field of the Invention

The invention relates to an air filter, more particularly to an air filter with molded end caps.

2. Description of the Related Art

Industrial equipment may be provided with an air filter to remove dust and contaminants. Referring to FIGS. 1 and 2, a conventional air filter is shown to comprise a tubular outer mesh body 2, a tubular inner mesh body 1 coaxially disposed in the tubular outer mesh body 2, a filter layer 3 disposed around the inner mesh body 1 and surrounded by the outer mesh body 2, and a first end cap 4 and a second end cap 5 mounted on opposite end portions of the mesh bodies 1, 2 so as to position the filter layer 3 therebetween. Each of the outer and inner mesh bodies 2, 1 is formed with a plurality of perforations 201, 101. The filter layer 3 is formed as a corrugated fibrous paperboard. The first and second end caps 4, 5 may be formed from rigid plastic or metal. The first end cap 4 is further formed with a through hole 401 therethrough.

In use, the air filter is disposed in a housing 10 (see FIG. 2) that has a removable cap. The housing 10 has an inlet pipe 11 and an outlet pipe 12. The outlet pipe 12 extends fittingly into the through hole 401 in the first end cap 4. When air enters into the housing 10 via the inlet pipe 11, the perforations 201 of the outer mesh body 2 are used to filter out larger grains of contaminants. Thereafter, when air flows into the inner mesh body 1, the filter layer 3 functions to filter out smaller grains of contaminants. As such, clean air can flow through the outlet pipe 12.

The following are some of the drawbacks of the aforesaid conventional air filter:

1) Since the first end cap 4 and the second end cap 5 are made of either rigid plastic or metal, manual labor is needed to mount the first and second end caps 4, 5 on the inner and outer mesh bodies 1, 2, such as by adhesives or by soldering, which is a troublesome task. Furthermore, in order to yield a good air sealing effect, the engagement among the first and second end caps 4, 5 and the inner and outer mesh bodies 1, 2 must be precise, which mandates high manufacturing accuracy for each of the aforesaid components, thereby resulting in high manufacturing costs.

2) As shown in FIG. 2, a sharp corner is formed at the engaging area between the bottom side of the first end cap 4 and one end portion of the inner mesh body 1. As such, turbulence will be generated at the sharp corner as filtered air flows out of the inner mesh body 1 and can interfere with smooth fluid flow through the outlet pipe 12. When applied to engines, this can result in incomplete combustion and lower the ignition efficiency.

### SUMMARY OF THE INVENTION

Therefore, the object of the present invention is to provide an air filter with molded end caps to overcome the aforesaid drawbacks of the prior art.

Accordingly, an air filter of this invention comprises a tubular outer mesh body, a tubular inner mesh body, a filter layer, and first and second end caps.

The tubular outer mesh body has perforated first and second tube end portions.

The tubular inner mesh body is coaxially disposed in the tubular outer mesh body and has perforated first and second tube end portions.

The filter layer is disposed around the inner mesh body and is surrounded by the outer mesh body.

The first end cap is molded from a plastic foam material, formed with an air outlet, and has a first inner ring flange that surrounds the air outlet, and a first outer ring flange that surrounds the first inner ring flange. The first inner ring flange has the first tube end portion of the inner mesh body embedded therein and fills perforations in the first tube end portion of the inner mesh body. The first outer ring flange has the first tube end portion of the outer mesh body embedded therein and fills perforations in the first tube end portion of the outer mesh body.

The second end cap is molded from a plastic foam material, and has a second inner ring flange and a second outer ring flange that surrounds the second inner ring flange. The second inner ring flange has the second tube end portion of the inner mesh body embedded therein and fills perforations in the second tube end portion of the inner mesh body. The second outer ring flange has the second tube end portion of the outer mesh body embedded therein and fills perforations in the second tube end portion of the outer mesh body.

The first and second end caps cooperate to position the filter layer between the inner and outer mesh bodies.

Preferably, the filter layer has opposite ends embedded in the first and second end caps, respectively.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a conventional air filter;

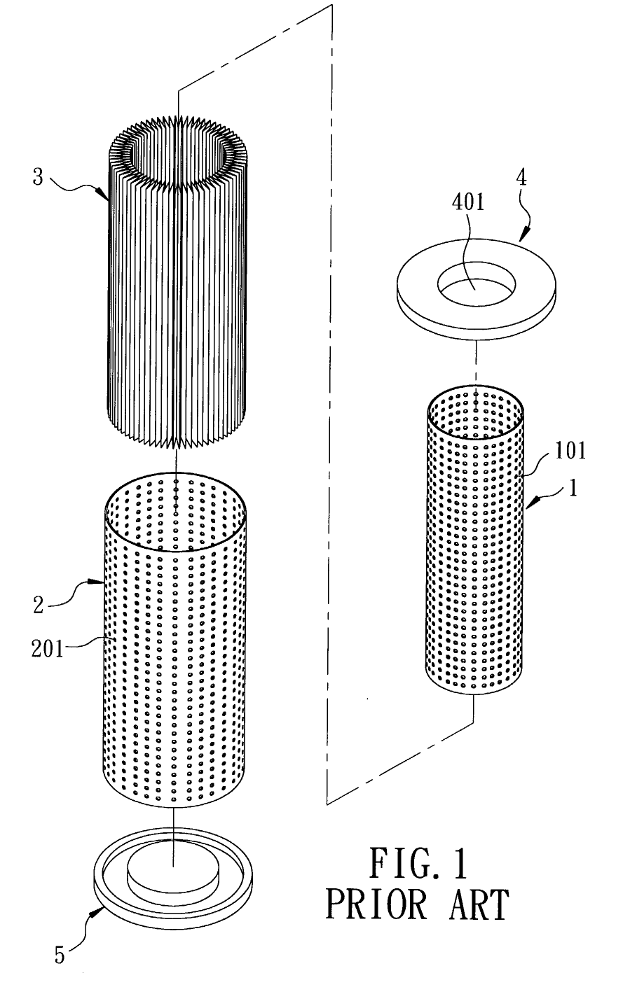

FIG. 2 is an assembled sectional view of the conventional air filter of FIG. 1 in a state of use;

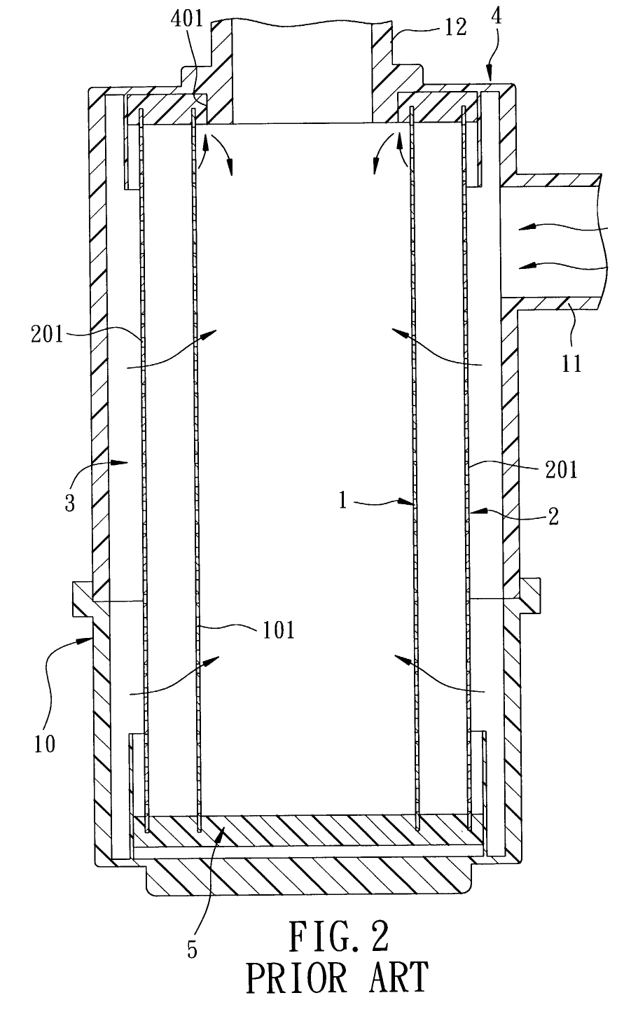

FIG. 3 is a perspective view of the first preferred embodiment of an air filter according to the present invention;

FIG. 4 is an assembled sectional view of the first preferred embodiment in a state of use;

FIG. 5 is a cross-sectional view of the first preferred embodiment;

FIG. 6 is an enlarged fragmentary view of FIG. 5; and

FIG. 7 is a schematic sectional view of the second preferred embodiment of an air filter according to the present invention.

### DETAILED DESCRIPTION OF THE PREFERRED EMBODIMENTS

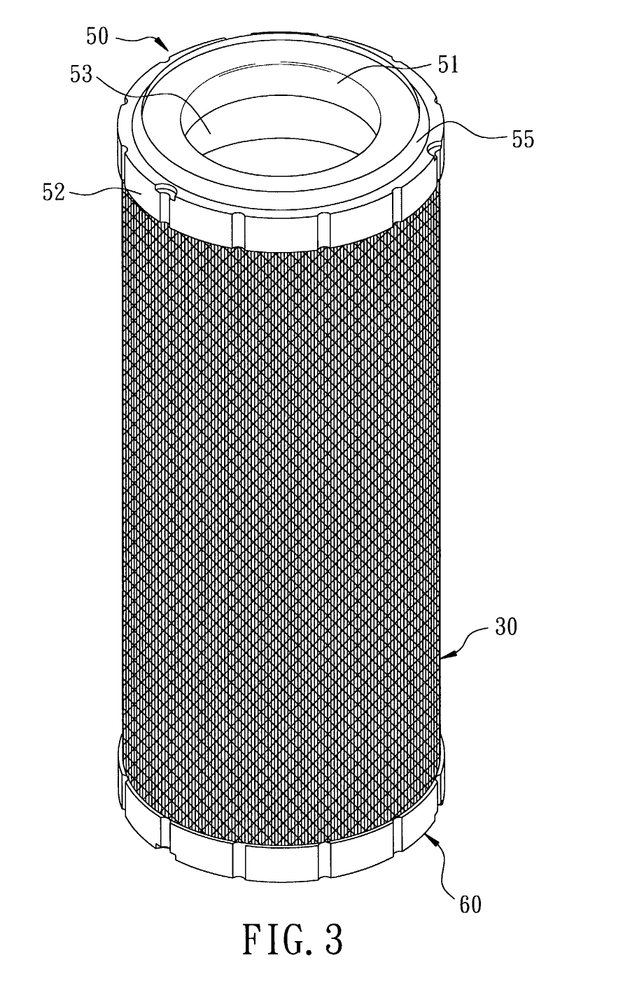

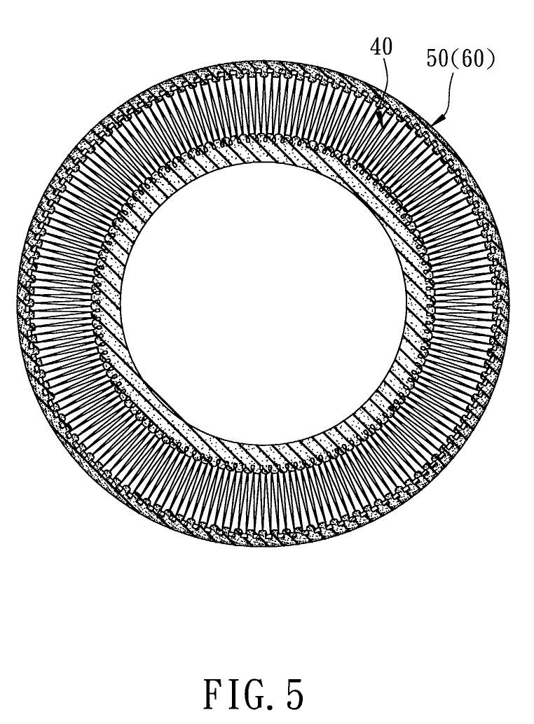

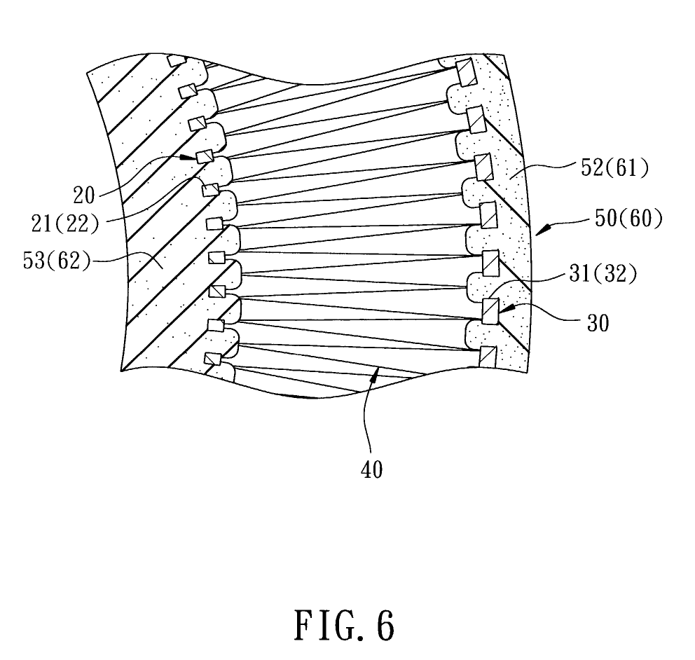

Referring to FIGS. 3 to 6, the first preferred embodiment of an air filter according to the present invention is shown to include a tubular outer mesh body 30, a tubular inner mesh body 20, a filter layer 40, and first and second end caps 50, 60.

The tubular outer mesh body 30 has a perforated first tube end portion 31 and a perforated second tube end portion 32.

The tubular inner mesh body 20 is coaxially disposed in the tubular outer mesh body 30 and has a perforated first tube end portion 21 and a perforated second tube end portion 22.

The filter layer 40 is formed as a corrugated fibrous paperboard, is disposed around the inner mesh body 20, and is surrounded by the outer mesh body 30.

The first end cap 50 is molded from a plastic foam material, is formed with an air outlet 51, and has a first inner ring flange 53 that surrounds the air outlet 51, and a first outer ring flange 52 that surrounds the first inner ring flange 53. The first inner ring flange 53 has the first tube end portion 21 of the inner mesh body 20 embedded therein and fills perforations in the first tube end portion 21 of the inner mesh body 20. The first outer ring flange 52 has the first tube end portion 31 of the outer mesh body 30 embedded therein and fills perforations in the first tube end portion 31 of the outer mesh body 32. The first endcap 50 further has an end wall face 54 opposite to the first inner and outer ring flanges 53, 52 and formed with an annular seal protrusion 55. The first inner ring flange 53 has an inner flange surface 532 that confines a tapered guide passage that is gradually reduced in a direction toward the air outlet 51 and that is in fluid communication with the air outlet 51. The inner wall confining the air outlet 51 may be further formed with a plurality of trapezoidal flanges (not shown) for enhancing sealing engagement.

The second end cap 60 is molded from a plastic foam material, and has a second inner ring flange 62 and a second outer ring flange 61 that surrounds the second inner ring flange 62. The second inner ring flange 62 has the second tube end portion 22 of the inner mesh body 20 embedded therein and fills perforations in the second tube end portion 22 of the inner mesh body 20. The second outer ring flange 61 has the second tube end portion 32 of the outer mesh body 30 embedded therein and fills perforations in the second tube end portion 32 of the outer mesh body 30.

When forming the first and second end caps 50, 60, the assembly of the inner and outer mesh bodies 20, 30 and the filter layer 40 are first disposed in a mold. Thus, the first and second end caps 50, 60 can be formed integrally with the inner and outer mesh bodies 20, 30 and can have opposite ends of the filter layer 40 embedded therein. In this manner, the first and second end caps 50, 60 can cooperate to position the filter layer 40 between the inner and outer mesh bodies 20, 30.

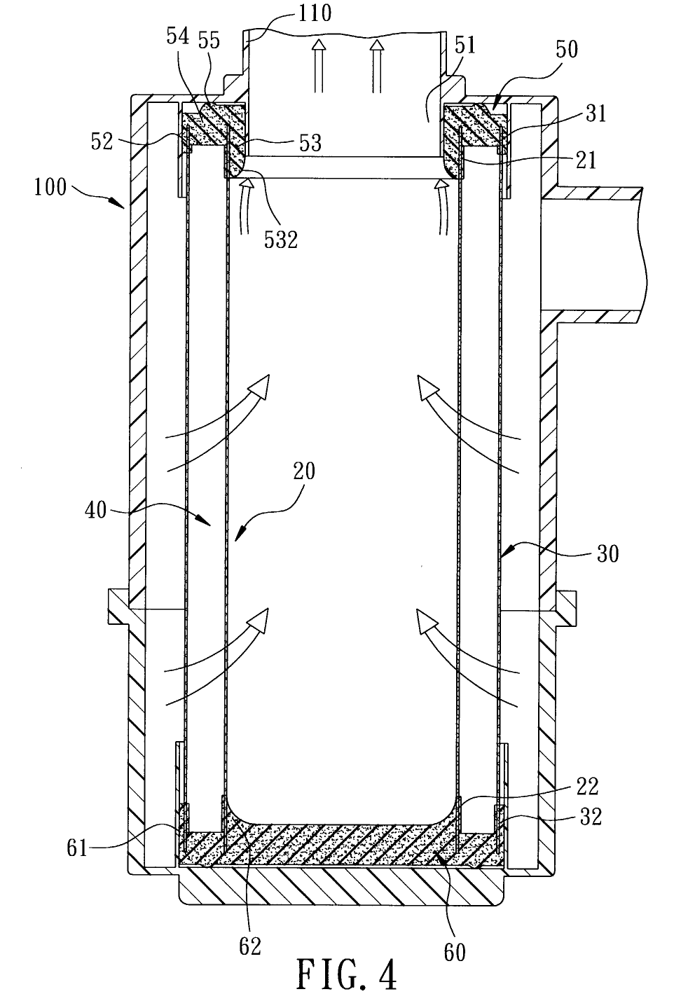

Referring once again to FIG. 4, the air filter is shown to be installed in a housing 100. An outlet pipe 110 of the housing 100 extends sealingly into the air outlet 51. The seal protrusion 55 of the first end cap 50 abuts against an inner wall of the housing 100. Filtered air flows smoothly through the air outlet 51 via the tapered guide passage confined by the inner flange surface 532.

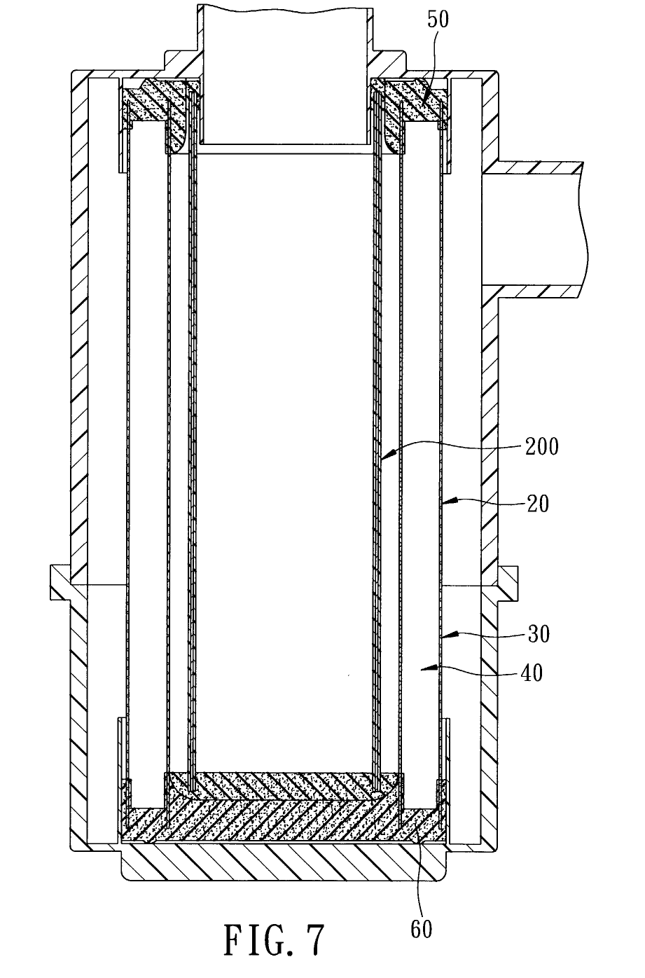

FIG. 7 illustrates the second preferred embodiment of an air filter according to the present invention. Unlike the previous embodiment, a second filter layer 200 is disposed in the inner mesh body 20 and also has opposite ends embedded in the first and second end caps 50, 60.

Because the end caps 50, 60 of the air filter according to this invention can be integrally formed in a mold in an automated manner, lower labor costs are incurred as compared to the conventional air filter described beforehand without mandating high manufacturing accuracy. Furthermore, the presence of the tapered guide passage confined by the inner flange surface 532 minimizes the problem of air turbulence as encountered in the aforesaid conventional air filter.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An air filter comprising:
a tubular outer mesh body having perforated first and second tube end portions;
a tubular inner mesh body coaxially disposed in said tubular outer mesh body and having perforated first and second tube end portions;
a filter layer disposed around said inner mesh body and surrounded by said outer mesh body;
a first end cap molded from a plastic foam material, formed with an air outlet, and having a first inner ring flange that surrounds said air outlet, and a first outer ring flange that surrounds said first inner ring flange, said first inner ring flange having said first tube end portion of said inner mesh body embedded therein and filling perforations in said first tube end portion of said inner mesh body, said first outer ring flange having said first tube end portion of said outer mesh body embedded therein and filling perforations in said first tube end portion of said outer mesh body; and
a second end cap molded from a plastic foam material, and having a second inner ring flange and a second outer ring flange that surrounds said second inner ring flange, said second inner ring flange having said second tube end portion of said inner mesh body embedded therein and filling perforations in said second tube end portion of said inner mesh body, said second outer ring flange having said second tube end portion of said outer mesh body embedded therein and filling perforations in said second tube end portion of said outer mesh body;
said first and second endcaps cooperating to position said filter layer between said inner and outer mesh bodies.

2. The air filter as claimed in claim 1, wherein said first end cap has an end wall face opposite to said second end cap and formed with a seal protrusion.

3. The air filter as claimed in claim 1, wherein said first inner ring flange has an inner flange surface that confines a tapered guide passage that is gradually reduced in a direction away from said second end cap and that is in fluid communication with said air outlet.

4. The air filter as claimed in claim 1, wherein said filter layer is formed as a corrugated fibrous paperboard.

5. The air filter as claimed in claim 1, wherein said filter layer has opposite ends embedded in said first and second end caps, respectively.

6. The air filter as claimed in claim 1, further comprising a second filter layer disposed in said inner mesh body and having opposite ends embedded in said first and second end caps, respectively.
